(19) United States
(12) Patent Application Publication
(10) Pub. No.: US 2009/0279287 A1
(43) Pub. Date: Nov. 12, 2009

(54) ELEVATED LIGHT WITH A SAFETY POWER CUT-OFF SWITCH

(75) Inventor: Russell Lewis Tartock, Springfield, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/115,796

(22) Filed: May 6, 2008

(51) Int. Cl. E01F 9/00; H01H 73/00

(52) U.S. Cl. 362/153.1; 361/115

(57) ABSTRACT

An elevated light apparatus for an airport runway light system comprises a mast mounted to a base plate, which is attached to a base-cup. The mast can be designed with a hollow configuration to allow internal electrical connection between a light source in a light assembly and an isolation transformer in the base-cup. The mast can include a frangible break joint that cleanly separates the mast from the base plate. A safety power cut-off switch can be fixed into the base plate on the base-cup. The power cut-off switch can be positioned in the frangible break joint so that a switch button can be held closed by a breakaway portion of the frangible break joint. In the event of mast breakage, the switch button can be released to open electrical circuits for quick disconnection of the electrical connection.

### TECHNICAL FIELD

Embodiments are generally related to airport runway light systems and installations. Embodiments are also related to elevated lights for use in airport runway light systems. Embodiments are additionally related to safety power cut-off switches utilized in the context of elevated lights.

### BACKGROUND OF THE INVENTION

Modern airports incorporate numerous specialized elevated lighting systems for illuminating the edge of an airport runway, taxiway and parking areas and to minimize the possibility that an aircraft may inadvertently travel off the edge of the runway. A typical elevated lighting system includes the use of (but is not limited to) approach lights, threshold and runway end, runway edge, and taxiway edge lighting systems. In particular, the United States FAA (Federal Aviation Administration) and a variety of aviation regulating agencies across the globe have mandated the use of elevated lights along runway edges and strongly recommend taxiway edge lights for certain low visibility operations. The elevated lights can be specially designed to define the edge limits of runways and taxiways and inhibit pilots from inadvertently driving airplanes off the designated runways and taxiways.

Elevated lights can include the use of a light fixture assembly that is attached to a base cup embedded in the ground. A typical light fixture assembly includes a mast with an end, which is attached to a coupling of a base cup, and an opposing end that carries a light fixture. The mast projects upwardly from the coupling of the base cup and support the light fixture above the ground in order to provide elevated lighting. An electrical plug is typically provided at the bottom of the mast to couple the electrical wiring of the light fixture to the electrical wiring of the airport.

Such elevated lights may also include a frangible joint at the base of the mast in the coupling region of the base cup. The frangible joint is referred as a frangible coupling. The frangible joint permits the coupling of the base cup to break when struck by a plane or other vehicle, which is a common occurrence at the airports. The electrical plug can be adapted to decouple when the coupling breaks to prevent damage to the electrical wiring of the airport. Such a frangible joint can separate the light fixture assembly from the coupling attached thereto to fall away from the base to minimize damage to the aircraft.

In the majority of prior art elevated lights, the light fixture assembly with the mast can be broken away from the base when the elevated light is struck by the airplane. Hence, the electrical connection can be disconnected by means of an electrical plug when the mast is separated from the base cup. The disconnection of the electrical plug typically leaves an open circuit of, for example, 6.6 amps and upwards of 480 volts alternating current (VAC), which can lead to a potential hazard for maintenance workers and environments. Therefore, it is desirable to provide some technique or apparatus for disconnecting the power from the power coupler to achieve a safe and operational airfield lighting system without the need to disconnect the wire in the mast.

In an effort to address the foregoing difficulties, it is believed that a need exists for an improved elevated light that enables a quick disconnection of the electrical connection in the event of mast breakage. It is believed that the improved elevated light disclosed herein can address these and other continuing needs.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved elevated light for airport runway light systems.

It is another aspect of the present invention to provide for a safety power cut-off switch utilized in the context of elevated lights.

The aforementioned aspects and other objectives and advantages can now be achieved as described herein. An improved elevated light for an airport runway light system comprises a mast mounted to a base plate, which is attached to a base-cup. The mast can be designed as hollow to allow internal electrical connection between a light source in a light assembly and an isolation transformer in the base-cup. The mast can include a frangible break joint that cleanly separates the mast from the base plate. A safety power cut-off switch can be fixed into the base plate on the base-cup. The power cut-off switch can be positioned in the frangible break joint so that a switch button can be held closed by a breakaway portion of the frangible break joint. In the event of mast breakage, the switch button can be released to open electrical circuits for quick disconnection of the electrical connection.

Furthermore, the light assembly, the mast and the base-cup can be arranged in a substantially vertical alignment. The mast can be attached with the light source of the light assembly utilizing a set of screws. The frangible joint can also be referred to as a “frangible coupling” and an insert associated with the frangible coupling can be provided near to the power cut-off switch. The power cut-off switch can be designed as a micro switch, which is normally closed when the switch button is depressed. The power cut-off switch can be opened for turning off power to connectors attached to the base plate when the mast is damaged. Hence, it enables easy and safe repair of the elevated light after the mast breakage without the need to disconnect power to a light fixture.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic cross-sectional view of an elevated light for an airport runway light system, in accordance with a preferred embodiment;

FIG. 2 illustrates an enlarged view of the elevated light, as shown in FIG. 1, with a safety power cut-off switch, in accordance with a preferred embodiment; and

FIG. 3 illustrates a top plan view of an airport runway light system incorporating airport elevated lights constructed and arranged, in accordance with a preferred embodiment.

### DETAILED DESCRIPTION

The particular values and configurations discussed in these non-limiting examples can be varied and are cited merely to illustrate at least one embodiment and are not intended to limit the scope thereof.

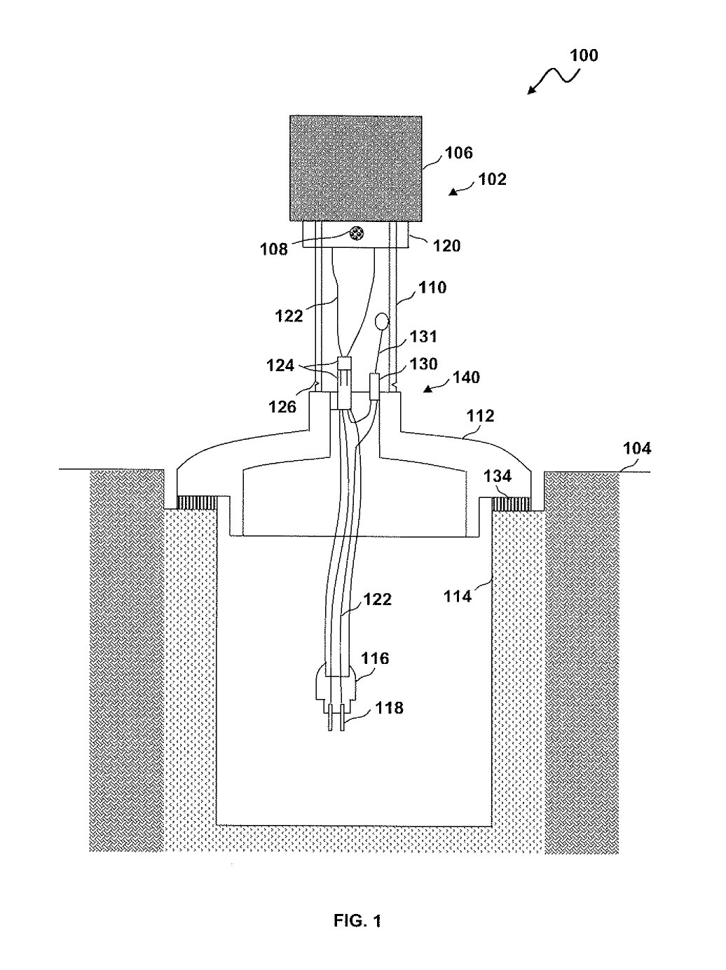

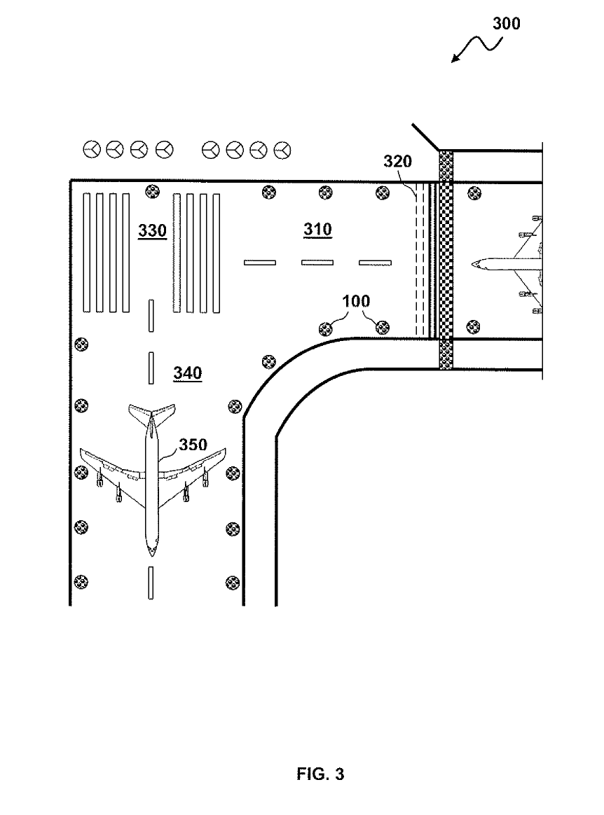

FIG. 1 illustrates a schematic cross-sectional view of an elevated light 100 for an airport runway light system 300, as illustrated in FIG. 3, in accordance with a preferred embodiment. The elevated light 100 typically includes a light assembly 102 elevated above the surface of ground 104 by utilizing a mast 110. The light assembly 102 can incorporate a light source 106 that is secured at the mast 110 with the assistance of a threaded component, such as, for example, a screw 108. The mast 110 can be mounted to a base plate 112, which is attached to a base-cup 114 (e.g., an L-867 base cup). Note that the embodiments discussed herein generally relate to the airport runway light system 300. It can be appreciated, however, that such embodiments can be implemented in the context of other lighting systems and designs and are not limited to the airport runway light system 300. The discussion of airport runway light systems 300, as utilized herein, is presented for general illustrative purposes only.

Moreover, the mast 110 and the base plate 112 can be combined to act as a light fixture 140. The light fixture 140 can be mounted on the ground 104 with the help of mounting means 134. The base-cup 114 can provide a source of power through a power coupler 116 by utilizing a set of electrical leads 118. The power coupler 116 can further be connected with a main power line (not shown) in the airport runway light system 300. The power coupler 116 can act as an isolation transformer for coupling power from the main power line, which extends to one or more elevated lights 100 through the ground 104. Such an isolation transformer 116 in the base-cup 114 can provide the required power to the light source 106 via the mast 110.

The mast 110 secures to the base-cup 114 to provide a stable support for the light assembly 102 during harsh weather conditions or other conditions impacting operation and/or orientation of the elevated light 100. The light assembly 102, the mast 110 and the base-cup 114 can be arranged in a substantially vertical alignment. An adjustment means 120 can be provided at the junction of the base of the light assembly 102 and the mast 110 so that the light source 106 can be adjusted to maintain a vertical orientation. The mast 110 can be designed as hollow to allow internal electrical wires 122 between the light source 106 in the light assembly 102 and a set of connectors 124 in the base-cup 114.

The mast 110 further includes a frangible break joint 126 that enables an easy breakaway of the mast 110 from the base plate 112 when an airplane 350, as illustrated in FIG. 3, maintenance vehicle or other forces exert a predetermined pressure on the frangible joint 126 sufficient to cause breaking thereof. The frangible break joint 126, which can be referred to as a frangible coupling, can be inserted near a safety power cut-off switch 130 of the elevated light 100. The power cut-off switch 130 can be fixed into the base plate 112 on the base-cup 114. The power cut-off switch 130 can be positioned in the frangible break joint 126 so that a switch button 131 can be held closed by a breakaway portion of the frangible break joint 126. In the event of mast breakage, the switch button 131 can be released to open electrical circuits for quick disconnection of the electrical connection between the light fixture 116 and the connectors 124 in the mast 110.

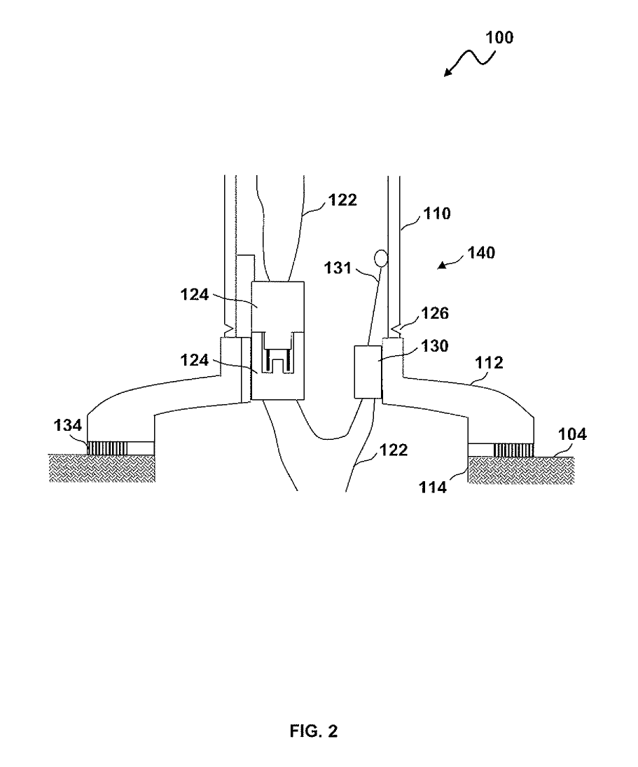

FIG. 2 illustrates an enlarged view of the elevated light 100, as shown in FIG. 1, with a safety power cut-off switch 130, in accordance with a preferred embodiment. Note that in FIGS. 1-3, identical parts or elements are generally indicated by identical reference numerals. The base plate 112 can be mounted on the base-cup 114 in order to allow installation of the elevated light 100. The base plate 112 can be made up of corten aluminum or steel with aviation yellow enamel finish, depending upon design considerations. It can be appreciated, of course, that other materials may be utilized to implement the base plate 112.

In addition, the frangible break joint 126 includes a groove or insert that is scored into the mast 110. The mast 110 is a single piece of hollow pipe extending from the light assembly 102 to the base plate 112. The groove or the insert of the frangible joint 126 can be designed with a sufficient length, depth, and orientation in the mast 110 to facilitate separation of the lighting assembly 102 and the light fixture 140 from the base plate 112 at or near the surface of the ground 104. In any case, the function of the frangible coupling 126 is to facilitate a breakaway function under stressed conditions to protect the elevated light 100 and the airplane 350 from major damage.

Such a frangible coupling 126 can provide a permanent and/or temporary mounting system for the elevated lights 100. The frangible coupling 126 can be manufactured based on FAA (Federal Aviation Administration) compliance for high and medium intensity edge light requirements. Additionally, the base-cup 114 can be acted as a blank cover to house the power coupler 116. The power coupler 116 can be operatively and electrically connected to the light source 106 of the light assembly 102 via the power cut-off switch 130 for providing power thereto. The power cut-off switch 130 can be designed as a micro switch, which is normally closed when the switch button 131 is depressed. The power cut-off switch 130 can be opened for turning off power to the connectors 124 attached to the base plate 112 when the mast 110 is damaged. Hence, it enables easy and safe repair of the elevated light 100 after the mast breakage without the need to disconnect power to the light fixture 140.

FIG. 3 illustrates a top plan view of an airport runway light system 300 incorporating airport elevated lights 100 constructed and arranged in accordance with a preferred embodiment. The airport elevated lights 100 can be installed on a side of a runway/taxiway 310 and/or near to a hold line 320 for a runway entrance control at a controlled or uncontrolled airfield. These elevated lights 100 can provide a clear illumination to the runway/taxiway 310, or an intersection 330 of the runway 310 with another runway/taxiway 340. The elevated lights 100 can also guide pilots to drive airplanes 350 in the runways/taxiways 310 and 340 after reaching a runway holding position identified by the hold line 320. The elevated lights 100 can be secured to the in-ground base-cup 114 and electrically coupled to electrical systems (not shown) of the airport runway light system 300.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An elevated light apparatus, comprising:
a light assembly including at least one light source for generating light, wherein said at least one light source is elevated above a ground surface;
a mast, associated with said at least one light source, and mounted to a base plate that in turn is attached to a base-cup, wherein said mast includes a frangible break joint at a base thereof for cleanly separating said mast from said base plate; and
a safety power cut-off switch fixed into said base plate on said base-cup, wherein said safety power cut-off switch is positioned in said frangible break joint so that a switch button is held closed by a breakaway portion of said frangible break joint.

2. The elevated light apparatus of claim 1 wherein said mast comprises a hollow portion that allows a plurality of internal electrical wires to be located between said at least one light source and a plurality of connectors attached to said base plate.

3. The elevated light apparatus of claim 1 wherein said switch button is releasable to open multiple electrical circuits for turning off power to said plurality of connectors, when said mast is damaged.

4. The elevated light apparatus of claim 1 wherein said frangible break joint comprises a frangible coupling, into which an insert is provided proximate to said safety power cut-off switch.

5. The elevated light apparatus of claim 1 wherein said safety power cut-off switch comprises a micro switch that is normally closed when said switch button is depressed.

6. The elevated light apparatus of claim 1 wherein said at least one light source, said mast and said base-cup are arranged in a substantially vertical alignment.

7. The elevated light apparatus of claim 1 wherein said at least one light source is secured at said mast utilizing at least one threaded component.

8. The elevated light apparatus of claim 1 wherein said elevated light apparatus is installed on a side of an airport runway.

9. The elevated light apparatus of claim 1 wherein said elevated light apparatus is installed on a side of an airport taxiway.

10. An elevated light apparatus, comprising:
a light assembly including at least one light source for generating light, wherein said at least one light source is elevated above a ground surface;
a mast, associated with said at least one light source, and mounted to a base plate that in turn is attached to a base-cup, wherein said mast includes a frangible break joint at a base thereof for cleanly separating said mast from said base plate, wherein said mast comprises a hollow portion that allows a plurality of internal electrical wires to be located between said at least one light source and a plurality of connectors attached to said base plate; and
a safety power cut-off switch fixed into said base plate on said base-cup, wherein said safety power cut-off switch is positioned in said frangible break joint so that a switch button is held closed by a breakaway portion of said frangible break joint.

11. The elevated light apparatus of claim 10 wherein said switch button is releasable to open multiple electrical circuits for turning off power to said plurality of connectors, when said mast is damaged.

12. The elevated light apparatus of claim 10 wherein said frangible break joint comprises a frangible coupling, into which an insert is provided proximate to said safety power cut-off switch.

13. The elevated light apparatus of claim 10 wherein:
said safety power cut-off switch comprises a micro switch that is normally closed when said switch button is depressed;
said at least one light source, said mast and said base-cup are arranged in a substantially vertical alignment; and
wherein said at least one light source is secured at said mast utilizing at least one threaded component.

14. The elevated light apparatus of claim 10 wherein said elevated light apparatus is installed on a side of an airport runway and/or on a side of an airport taxiway.

15. A method of forming an elevated light apparatus, comprising:
providing a light assembly including at least one light source for generating light;
elevating said at least one light source above a ground surface;
associating a mast with said at least one light source, said mast mounted to a base plate that in turn is attached to a base-cup;
configuring said mast to include a frangible break joint at a base thereof for cleanly separating said mast from said base plate; and
fixing a safety power cut-off switch into said base plate on said base-cup, wherein said safety power cut-off switch is positioned in said frangible break joint so that a switch button is held closed by a breakaway portion of said frangible break joint.

16. The method of claim 15 further comprising configuring said mast to include a hollow portion that allows a plurality of internal electrical wires to be located between said at least one light source and a plurality of connectors attached to said base plate.

17. The method of claim 15 further comprising:
configuring said switch button to be releasable to open multiple electrical circuits for turning off power to said plurality of connectors, when said mast is damaged; and
modifying said frangible break joint to comprise a frangible coupling, into which an insert is provided proximate to said safety power cut-off switch.

18. The method of claim 15 further comprising:
configuring said safety power cut-off switch to include a micro switch that is normally closed when said switch button is depressed; and
arranging said at least one light source, said mast and said base-cup in a substantially vertical alignment.

19. The method of claim 15 further comprising securing said at least one light source at said mast utilizing at least one threaded component.

20. The method of claim 15 further comprising installing said elevated light apparatus on a side of an airport runway and/or on a side of an airport taxiway.
